(19) United States
(12) Patent Application Publication
(10) Pub. No.: US 2014/0335280 A1
(43) Pub. Date: Nov. 13, 2014

(54) CONCEALMENT COMPOSITION AND METHOD

(71) Applicant: Allan Musser, Longmont, CO (US)

(72) Inventor: Allan Musser, Longmont, CO (US)

(21) Appl. No.: 13/891,798

(22) Filed: May 10, 2013

(51) Int. Cl. C09D 5/30; H04R 25/00

(52) U.S. Cl. CPC C09D 5/30; H04R 25/60
USPC 427/430.1; 118/428

(57) ABSTRACT

A concealment composition and method of application may provide a colored composition and a method of applying the composition on at least a portion of an object, such as a hearing aid transmission tube. The application of the composition to the object may be permanent. The composition may be comprised of a plurality of colored compositions, configured to be mixed to a desired color for adhering to at least a portion of the object. In some embodiments, the object may be configured to be operable to join with a body part. In this manner, a portion of the object may be camouflaged, integrating with the body part for enhanced aesthetics and functionality. A composition applicator may allow a concealable portion of the object to engage the composition, while a nonconcealable portion of the object remains without the composition for minimizing functionality problems for the object.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to concealment compositions. More particularly, the invention relates to concealment compositions and methods of application for hearing aids.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that a hearing aid is an electroacoustic device which typically fits in or behind the wearer's ear, and is designed to amplify and modulate sound for the wearer. Earlier devices, known as ear trumpets or ear horns, were passive funnel-like amplification cones designed to gather sound energy and direct it into the ear canal.

Typically, human skin color ranges in variety from the darkest brown to the lightest pinkish-white hues. Human skin shows higher variation in color than any other single mammalian species and is the result of natural selection.

Often, camouflage is the use of any combination of materials, coloration or illumination for concealment, either by making animals or objects hard to see, or by disguising them as something else. Skin color pigmentations may be used to camouflage an object on a body part.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIGS. 1A and 1B illustrate detailed perspective views of an exemplary concealment composition and an exemplary plurality of colored compositions on a color selection portion, in accordance with an embodiment of the present invention;

FIG. 2 illustrates a detailed perspective view of an exemplary object, in accordance with an embodiment of the present invention;

FIG. 3 illustrates a detailed perspective view of an exemplary concealment preparation portion, in accordance with an embodiment of the present invention; and

FIG. 4 illustrates a detailed perspective view of an exemplary composition applicator, in accordance with an embodiment of the present invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

Headings provided herein are for convenience and are not to be taken as limiting the disclosure in any way.

The enumerated listing of items does not imply that any or all of the items are mutually exclusive, unless expressly specified otherwise.

The terms “a”, “an” and “the” mean “one or more”, unless expressly specified otherwise.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may be configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

Those skilled in the art will readily recognize, in light of and in accordance with the teachings of the present invention, that any of the foregoing steps may be suitably replaced, reordered, removed and additional steps may be inserted depending upon the needs of the particular application. Moreover, the prescribed method steps of the foregoing embodiments may be implemented using any physical and/or hardware system that those skilled in the art will readily know is suitable in light of the foregoing teachings. For any method steps described in the present application that can be carried out on a computing machine, a typical computer system can, when appropriately configured or designed, serve as a computer system in which those aspects of the invention may be embodied. Thus, the present invention is not limited to any particular tangible means of implementation.

The present invention will now be described in detail with reference to embodiments thereof as illustrated in the accompanying drawings.

There are various types of concealment compositions and methods of application that may be provided by preferred embodiments of the present invention. In one embodiment of the present invention, the concealment composition and method of application may provide a colored composition and a method of applying the composition on a portion of an object. The application of the composition to the object may be permanent. The composition may comprise of a plurality of colored compositions, configured to be mixed to a desired color for adhering to at last a portion of the object. In some embodiments, the object may be configured to be operable to join with a body part. In this manner, a portion of the object may be camouflaged, integrating with the body part for enhanced aesthetics and functionality. A composition applicator may allow a concealable portion of the object to receive the composition, while a nonconcealable portion of the object remains without the composition for minimizing functionality problems for the object. The composition may contain chemical compounds that are derived from synthetic or organic materials such as, but not limited to, silicates, minerals, plants, resins, and animal products. The amount of each compound is adjusted to produce permanent dyes that will replicate human skin tones. In one embodiment of the present invention, the concealment composition may at least partially match the color of a body part. The body part may include, without limitation, ears, skin, teeth, hair, and fingernails. However, in other embodiments, the body part may include an item that joins with the body, including, without limitation, dentures, braces, jewelry, hair accessories, and garments. In some embodiments, the concealment composition may comprise a plurality of colored compositions, which may be formulated in any combination to achieve a desired color. A color selector portion may provide a sample of each colored composition. In one embodiment, the color selection portion may be comprised of colored rectangles, circles, ovals or squares that may be of any size and constructed of any material, including, but not limited to, paper, plastic, glass, or glassine. The color selection portion may help a user replicate the various shades of skin tones for all major races. For example, without limitation, paper tabs may be coated with each colored composition, whereby the colored tabs may be positioned in proximity to the skin to identify a similar skin tone for application on a hearing aid transmission tube. In some embodiments, each colored composition may include color indicia to differentiate between the pluralities of colored compositions. The color indicia may include, without limitation, a number, a text, and a picture that indicates the color of the colored composition. A color container may contain each colored composition prior to combination.

In one embodiment of the present invention, the concealment composition may be applied to the object after the plurality of colored compositions has been mixed and formulated into any combination. However, in other embodiments, a single colored composition may be utilized without further formulation. In some embodiments, the surface of the object may be prepared prior to receiving the concealment composition with a concealment preparation portion. The concealment preparation portion may include, without limitation, a flexible foam or plastic substrate coated with an abrasive material. However, in other embodiments, the concealment preparation portion may include a liquid abrasive used to prep polymers for painting or dying. In some embodiments, the concealment preparation portion may enhance the object by increasing the surface area of the object, permitting better penetration of the concealment composition, and decreasing the reflectance of light from the object.

In one embodiment of the present invention, the object may be positioned in a composition applicator for at least partially receiving the concealment composition. The composition applicator may include a container for at least partially immersing the object in the concealment composition. In this manner, the concealable portion of the object may engage the concealment composition, while the nonconcealable portion of the object may rest outside the composition applicator. A release portion may permit the nonconcealable portion of the object to rest outside the composition applicator. The release portion may include a groove, a hole or a port configured to at least partially allow a hearing aid transmission tube to pass through. A fastener may secure the nonconcealable portion of the object to restrict accidental engagement with the concealment composition. For example, without limitation, a hearing aid transmission tube is placed in the composition applicator so that a speaker dome sits outside of the composition applicator. The transmission tube slides down the release portion, such as a port through a retention sleeve that may restrict the concealment composition from leaking outside the composition applicator. Those skilled in the art, in light of the present teachings, will recognize that because of the shape of the hearing aid transmission tube, the fastener, such as an attachment clip, may position inside the composition applicator and perpendicular to a composition applicator base. When either or both of the hearing aid transmission tubes have been secured in the composition applicator the concealment composition may be poured into the composition applicator until the liquid level comes up to the base of the attachment clip or connector. In one embodiment, the composition applicator may be designed to protect the hearing aid attachment clip and speaker/dome from coming into contact with the concealment composition. In a further embodiment, after being immersed in the concealment composition for an adequate duration, the hearing aid transmission tubes may be removed from the composition applicator and cleaned and dried.

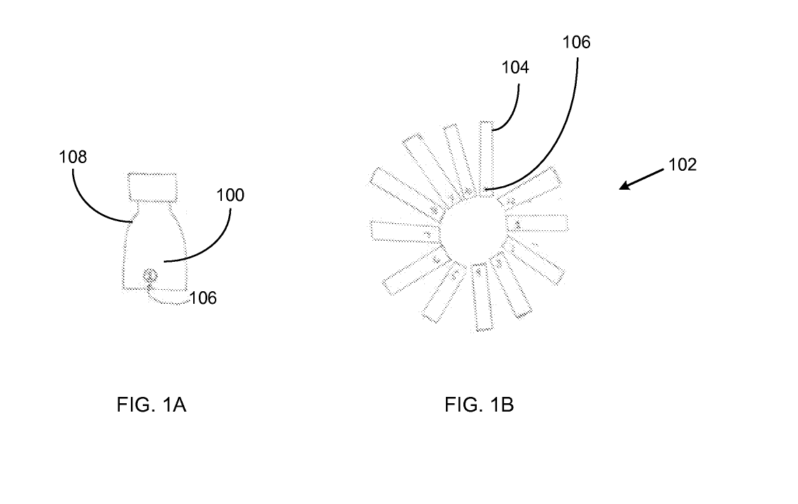

FIGS. 1A and 1B illustrate detailed perspective views of an exemplary concealment composition and an exemplary plurality of colored compositions on a color selection portion, in accordance with an embodiment of the present invention. In the present embodiment, the concealment composition and method of application may provide a colored composition and a method of applying the composition on at least a portion of an object. The concealment composition will produce an unlimited number of colors that will blend with human skin tones. For simplicity the inventor has suggested nine different shades that will blend with the extremes of the world's major ethnic groups. The application of the composition to the object may be permanent. The concealment composition may be comprised of a plurality of colored compositions, configured to be mixed to a desired color for adhering to at least a portion of the object. In some embodiments, the object may be configured to be operable to join with a body part. In this manner, a portion of the object may be camouflaged, integrating with the body part for enhanced aesthetics and functionality. A composition applicator may allow a concealable portion of the object to engage the composition, while a nonconcealable portion of the object remains without the composition for minimizing functionality problems for the object. Those skilled in the art, in light of the present teaching, will recognize that the stigma of wearing hearing aids is one of the major reasons for non-purchase, whereby the present embodiment allows the user to camouflage the existence of the hearing aid with a skin colored composition. The composition may also serve to help minimize reflective lights from the object.

In one embodiment of the present invention, a concealment composition 100 may at least partially match the color of a body part. The body part may include, without limitation, ears, skin, teeth, hair, and fingernails. However, in other embodiments, the body part may include an item that joins with the body, including, without limitation, dentures, braces, jewelry, hair accessories, and garments. In some embodiments, the concealment composition may comprise a plurality of colored compositions 102, which may be formulated in any combination to achieve a desired color. Those skilled in the art, in light of the present teachings, will recognize that there are myriad tones and hues of skin. The plurality of colored compositions combines in assorted combinations to at least partially match the skin color of a user.

In one embodiment of the present invention, a color selector portion 104 may provide a sample of each colored composition. In one embodiment, the color selection portion may be comprised of colored rectangles, circles, ovals or squares that may be of any size and constructed of any material, including, without limitation, paper, plastic, glass, or glassine. The color selection portion may help a user replicate the various shades of skin tones for all major races. For example, without limitation, paper tabs may be coated with each colored composition, whereby the colored tabs may be positioned in proximity to the skin to identify a similar skin tone for application on a hearing aid transmission tube. In some embodiments, each colored composition may include color indicia 106 to differentiate between the pluralities of colored compositions. The color indicia may include, without limitation, a number, a text, and a picture that indicates the color of the colored composition. In one embodiment, the concealment composition may include at least nine indicia. For example, without limitation, number 2 indicia indicate a lighter color than number 6 indicia. In one embodiment, a color container 108 may contain each colored composition prior to combination. The color container may include, without limitation, a glass jar, a plastic jar, a tray, and a vial.

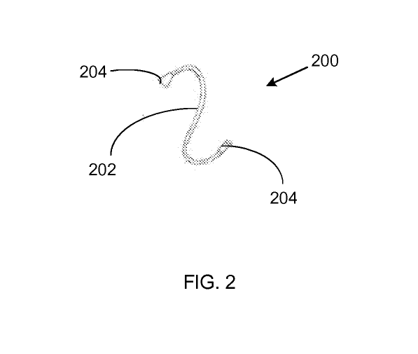

FIG. 2 illustrates a detailed perspective view of an exemplary object, in accordance with an embodiment of the present invention. In the present embodiment, the concealment composition may be applied to an object 200 after the plurality of colored compositions has been mixed and formulated into any combination. However, in other embodiments, a single colored composition may be utilized without further formulation for application to the object. The object may include, without limitation, a hearing aid transmission tube, a hearing speaker, a brace, and a denture. In some embodiments, the object may include a concealable portion 202 for receiving the concealment composition, and a nonconcealable portion 204 that does not receive the concealment portion. For example, without limitation, a hearing aid transmission tube may receive the concealment portion, while sensitive electrical components, such as the speaker remain unconcealed.

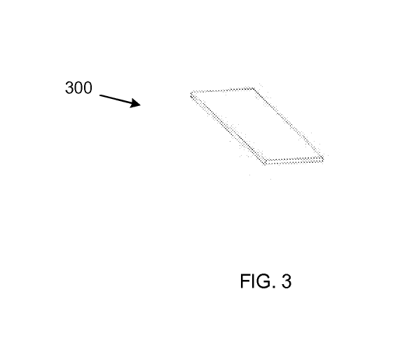

FIG. 3 illustrates a detailed perspective view of an exemplary concealment preparation portion, in accordance with an embodiment of the present invention. In the present embodiment, the surface of the object may be prepared prior to receiving the concealment composition with a concealment preparation portion 300. The concealment preparation portion may include, without limitation, a flexible foam or plastic substrate coated with an abrasive material. However, in other embodiments, the concealment preparation portion may include a liquid abrasive used to prep polymers for painting. In some embodiments, the concealment preparation portion may enhance the object by increasing the surface area of the object, permitting better penetration of the concealment composition, and decreasing the reflectance of light from the object.

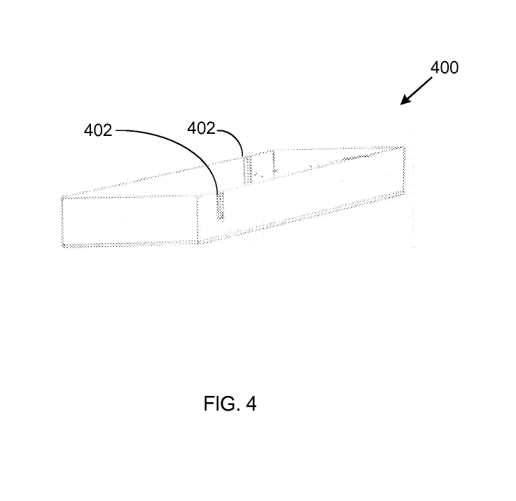

FIG. 4 illustrates a detailed perspective view of an exemplary composition applicator, in accordance with an embodiment of the present invention. In the present embodiment, the object may be positioned in a composition applicator 400 for at least partially receiving the concealment composition. In one embodiment, the composition applicator may include a vat that is configured to secure a hearing aid transmission tube for immersion in the concealment composition, and restricting a hearing aid ear bud and speaker from engagement with the concealment composition. In another embodiment the composition applicator may include an isolation mask that affixes to the tube connector and the tube is then placed in a vat, bottle or tube containing concealment composition. In yet another embodiment, the composition applicator may include a container for at least partially immersing the object in the concealment composition. In this manner, the concealable portion of the object may engage the concealment composition, while the nonconcealable portion of the object may rest outside the composition applicator. A release portion 402 may permit the nonconcealable portion of the object to rest outside the composition applicator. The release portion may include a groove configured to at least partially allow a hearing aid transmission tube to pass through.

In one embodiment of the present invention, a fastener may secure the nonconcealable portion of the object to the release portion for restricting accidental engagement with the concealment composition. For example, without limitation, a hearing aid transmission tube is placed in the composition applicator so that a speaker dome sits outside of the composition applicator. The transmission tube slides down the release portion, such as a port through a retention sleeve that may restrict the concealment composition from leaking outside the composition applicator. Those skilled in the art, in light of the present teachings, will recognize that because of the shape of the hearing aid transmission tube, the fastener, such as an attachment clip, may position inside the composition applicator and perpendicular to a composition applicator base. When either or both of the hearing aid transmission tubes have been secured in the composition applicator the concealment composition may be poured into the composition applicator until the liquid level comes up to the base of the attachment clip. In one embodiment, the composition applicator may be designed to protect the hearing aid attachment clip and speaker/dome from coming into contact with the concealment composition. In a further embodiment, after being immersed in the concealment composition for an adequate duration, the hearing aid transmission tubes may be removed from the composition applicator and cleaned and dried. The composition applicator may be comprised of any material that will contain a liquid and may be any shape or form, including, without limitation, rigid polymers, polyvinyl chloride, fiberglass, and metal.

In one alternative embodiment, the concealment composition may help conceal dentures in teeth. In yet another alternative embodiment, the concealment composition at least partially matches in color to an inanimate object. In yet another alternative embodiment, the composition applicator may include an air brush.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC §112 (1), all claims must be supported by sufficient disclosure in the present patent specification, and any material known to those skilled in the art need not be explicitly disclosed. However, 35 USC §112 (6) requires that structures corresponding to functional limitations interpreted under 35 USC §112 (6) must be explicitly disclosed in the patent specification. Moreover, the USPTO's Examination policy of initially treating and searching prior art under the broadest interpretation of a “mean for” claim limitation implies that the broadest initial search on 112(6) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC §112 (6) when such corresponding structures are not explicitly disclosed in the foregoing patent specification. Therefore, for any invention element(s)/structure(s) corresponding to functional claim limitation(s), in the below claims interpreted under 35 USC §112 (6), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC §112 (6) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC §112 (6), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC §112 (6). Applicant(s) note that all the identified documents above which are incorporated by reference to satisfy 35 USC §112 (6) necessarily have a filing and/or publication date prior to that of the instant application, and thus are valid prior documents to incorporated by reference in the instant application.

Having fully described at least one embodiment of the present invention, other equivalent or alternative methods of implementing a concealment composition for camouflaging an object with a body part, according to the present invention will be apparent to those skilled in the art. Various aspects of the invention have been described above by way of illustration, and the specific embodiments disclosed are not intended to limit the invention to the particular forms disclosed. The particular implementation of the a concealment composition for camouflaging an object with a body part may vary depending upon the particular context or application. By way of example, and not limitation, the a concealment composition for camouflaging an object with a body part described in the foregoing were principally directed to camouflaging hearing aids to ears implementations; however, similar techniques may instead be applied to camouflaging dentures in a mouth, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. A composition comprising:
a plurality of colored compositions, said plurality of colored compositions comprising an organic dye, said plurality of chemical compositions further comprising a chemical accelerant, said plurality of colored compositions being configured to at least partially blend together, said plurality of colored compositions further being configured to be operable to at least partially match a color of a body part, said plurality of colored compositions further being configured to at least partially cover an object permanently, said plurality of colored compositions being operable to permanently conceal said object in proximity to a body part; and
a composition applicator, said composition applicator being configured to contain said object for receiving said composition, said composition applicator being configured to engage a concealable portion of said object with said composition, said composition applicator comprising a release portion, said release portion being configured to restrict engagement of a nonconcealable portion of said object with said composition.

2. The system of claim 1, in which said object comprises a hearing aid transmission tube.

3. The system of claim 2, in which said concealable portion comprises said hearing aid transmission tube.

4. The system of claim 3, in which said nonconcealable portion comprises a speaker.

5. The system of claim 4, in which said body part comprises skin.

6. The system of claim 5, in which said plurality of colored compositions comprises at least nine skin toned colors.

7. The system of claim 6, in which said plurality of colored compositions comprise a color indicia, said color indicia comprising said at least nine skin toned colors.

8. The system of claim 7, in which said plurality of colored compositions comprises a color selection portion, said color selection portion being configured to help select from said plurality of colored compositions for at least partially matching said body part.

9. The system of claim 8, in which said color selection portion comprises a plurality of tabs having said color indicia.

10. The system of claim 9, wherein a composition container is configured to contain said composition, said composition container comprising said color indicia.

11. The system of claim 10, in which said release fastener comprises a slot or port configured to at least partially receive said hearing aid transmission tube.

12. The system of claim 11, wherein said composition is configured to be permanent and nonallergenic.

13. The system of claim 12, wherein said composition is operable to help restrict reflections from the object.

14. A method of applying a composition comprising:
mixing a plurality of colored compositions for forming a composition;
positioning an object in a composition applicator for receiving said composition;
immersing a concealment portion of said object in said composition;
restricting a nonconcealment portion of said object from engaging with said composition;
positioning said object in proximity to a body part; and
camouflaging said object with said body part.

15. A composition consisting of:
a plurality of colored compositions, said plurality of colored compositions comprising an organic or synthetic dye, said plurality of chemical compositions further comprising a chemical accelerant, said plurality of colored compositions comprising at least nine colored compositions, said plurality of colored compositions being configured to at least partially mix together, said plurality of colored compositions further being configured to be operable to at least partially match a color of a body part, said body part comprising skin, said plurality of colored compositions further being configured to at least partially cover an object, said object comprising a hearing aid transmission tube, said plurality of colored compositions being operable to conceal said object in proximity to a body part; and
a composition applicator, said composition applicator comprising a vat, said composition applicator being configured to contain said object for receiving said composition, said composition applicator being configured to engage a concealable portion of said object with said composition, said composition applicator comprising a release portion, said release portion comprising a groove, said release portion being configured to restrict engagement of a nonconcealable portion of said object with said composition, said release portion comprising a groove configured to at least partially receive said hearing aid transmission tube.
